(19) United States
(12) Patent Application Publication
(10) Pub. No.: US 2010/0237066 A1
(43) Pub. Date: Sep. 23, 2010

(54) COMB-LIKE SLIT LAMINATED YOKE FOR A TRAVELLING-MAGNETIC-FIELD INDUCTOR FOR REHEATING METAL STRIP

(75) Inventors: Alain Daubigny, Villerupt (FR); Marc Anderhuber, Saulny (FR)

Correspondence Address: OBLON, SPIVAK, MCCLELLAND MAIER & NEUSTADT, L.L.P., 1940 DUKE STREET, ALEXANDRIA, VA, 22314, US

(73) Assignees: ArcelorMittal France, Saint Denis (FR); Arcelormittal-Stainless France, Saint-Denis (FR)

(21) Appl. No.: 12/679,741

(22) PCT Filed: Sep. 18, 2008
(86) PCT No.: PCT/FR08/01303

§ 371 Date: Jun. 4, 2010

(30) Foreign Application Priority Data
Sep. 25, 2007 (EP) 07018793.5

(51) Int. Cl. H05B 6/36

(52) U.S. Cl. 219/672

(57) ABSTRACT

Yoke formed by a stack of magnetic laminations 4 that have mutually parallel edge notches 7 with open lips, these being located at least in the corners of the inductor.

These notches are preferably spaced apart by a few mm, but the separating interval may be higher, from 1 cm and beyond, without however exceeding about 5 cm. They start at the lamination edges and extend, preferably along straight lines, towards the interior over a distance that depends on the environment of the inductor. They are produced by removing material so that each notch 7 has non-touching lips (therefore open lips), even preferably at discrete points, so as to prevent offering bridges for the circulation of eddy currents thereat.

The invention applies to the production of heating inductors, by controlling the thermal behaviour of the inductors by simple means that prevent them from overheating.

The present invention relates to the rapid induction heating of continuously running metal strip in the solid state, especially steel strip. It relates more particularly to the production of the magnetic yoke in the form of laminations constituting the heating inductors in question.

To limit inductor overheating, it is usual practice to produce the yoke thereof as a stack of magnetic laminations electrically insulated from one another. The laminating direction, oriented along the direction of the magnetic field produced by the inductor, prevents the formation of eddy currents in perpendicular planes. The laminations themselves are moreover thin enough so that eddy currents cannot develop along the thickness direction significantly. This is because such parasitic currents are to be prohibited, at the risk otherwise of having to cool the yoke much more intensely than what would be sufficient for compensating for the heat influx coming from the workpiece itself which is to be heated, so as to maintain the inductor at a temperature level compatible with its stable operation over time.

As a general rule, laminating the yoke is sufficient for controlling the thermal level of usual heating inductors. However, in certain cases it is found that the cooling provided (by natural convention, by fans, etc.) is no longer sufficient and that forced heat extraction systems must then be envisaged, for example making use of heat pipes or a phase change in the heat-transfer fluid, or even relatively sophisticated cryogenic systems, which are not always compatible with the economic constraints on the inductive heating operation to be carried out. This is especially the case for powerful inductors generating what is called a “travelling” magnetic field, such inductors having to be constructed at the present time in order to achieve very rapid heating rates, raising the temperature by several hundred degrees Celsius in a few seconds. An application example currently under development is that for the inductive heating of steel strip running rapidly (around several hundred metres per minute) through a continuous annealing line, the inductor then being made up from two paired plane half-parts, placed facing each other a short distance apart so as to leave between them a corridor gap generating an intense pulsating magnetic field, the strip to be heated passing through said gap.

However, detailed analysis of the origins and causes of intrinsic overheating (reflex thermal radiation returning from the heated product excluded) carried out in the Applicant's laboratories has provided simple unsophiscated technological solutions incurring no or virtually no operating cost, it being sufficient to employ customary inductor cooling means in order to maintain inductor thermal stability at a satisfactory temperature level in most cases.

For this purpose, the subject of the invention is a heating inductor yoke of plane general structure generating a travelling magnetic field, said yoke being formed from a stack of magnetic laminations, characterized in that said laminations making up the yoke have mutually parallel edge notches with open lips, these being located at least in the corners of the inductor.

These notches are preferably spaced apart by a few mm, but the separating interval may be higher, from 1 cm and beyond, without however exceeding about 5 cm, at the risk otherwise of losing the expected efficiency.

They start at the lamination edges and extend, preferably along straight lines, towards the interior over a distance, ranging from a few cm to a few dm, that depends on the environment of the inductor. They are produced by removing material so that each notch has non-touching lips (therefore open lips) and preferably without mutual, even discrete, contact so as to prevent offering bridges for the circulation of eddy currents thereat.

As will have been understood, the invention therefore lies in a magnetic yoke, conventionally intended to channel the magnetic field lines of force in a heating inductor that produces this magnetic field, the yoke being produced by a stack of magnetic laminations partially slit on the periphery thereof as a replacement for the usual unnotched laminations.

The yoke thus retains its primary role of concentrating the magnetic field and prevents induced currents from developing in all directions, thus eliminating any undesirable overheating, thereby making it much easier to use the inductor.

It has been observed that the conventional principle of constructing magnetic yokes from laminations with the laminating direction oriented along the direction of the incident magnetic field produced by the electrical windings of the inductor, operates well when this magnetic field direction is known, stable and well controlled, namely precisely parallel to the laminating direction. However, there are magnetic configurations in which the magnetic field does not have everywhere the same direction of propagation of its lines of force in the space that it occupies. Thus, in the corners of the inductor, where the latter is generally closest to its external material environment, the magnetic field may sometimes loop back over the edge of the yoke after having naturally followed the paths of least reluctance among those that are offered to it. In the case of inductors with a high heating power (the invention was initially proposed for them), the induced parasitic currents, which then develop on the unnotched face of the sheets making up the yoke, may, under these conditions, cause strong local overheating, thus limiting the use of the inductor, whereas its average thermal level nevertheless remains completely compatible with a durable normalized state of operation.

Such local overheating is avoided thanks to the means of the invention, which consists simply of open peripheral notches having non-touching edges provided in the sheets making up the magnetic laminations of the yoke, at least at the places therein where this overheating causes a problem.

The origin of any local overheating lies in the singular spatial topology of the magnetic field lines of force stemming from the magnetic properties of the immediate material environment of the inductor in these particular places (looping along a direction more or less perpendicular to the large faces of the laminations).

The parallel spaced-apart notches of the invention, which are open since they start from the edges of the laminations, therefore give the yoke a comb shape at the places where such undesirable overheating would otherwise limit the use of the inductor.

The invention will be clearly understood and other aspects and advantages thereof will become more clearly apparent in view of the following description given with reference to the single appended plate of drawings in which:

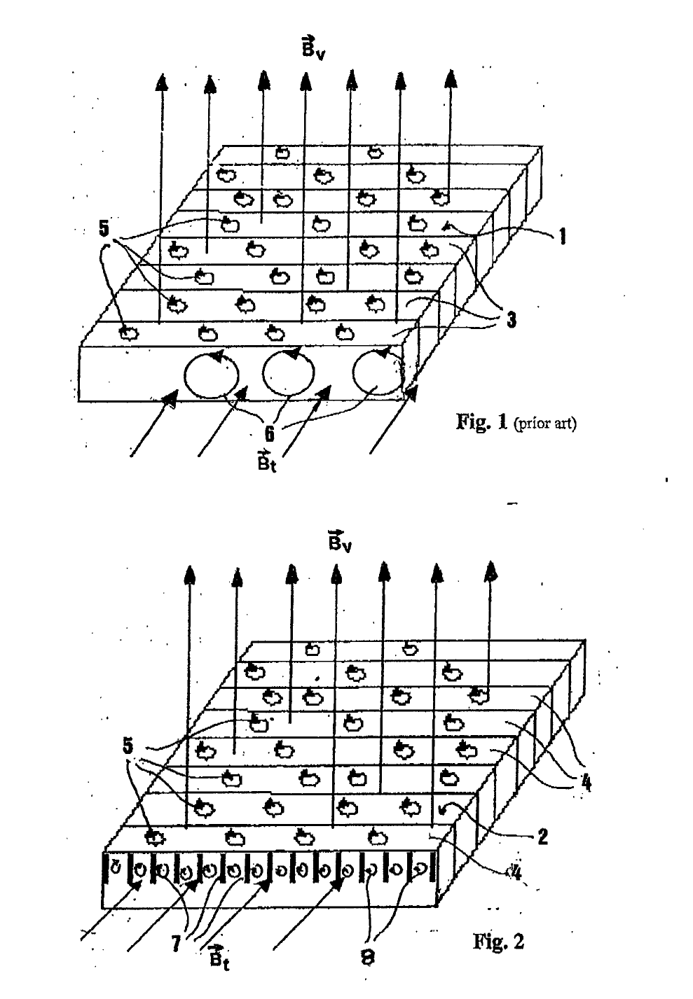

FIG. 1 shows schematically a portion of a conventional magnetic yoke located at a corner of a plane heating inductor generating a magnetic field of the “travelling” type; and

FIG. 2 is a diagram similar to FIG. 1, but showing a yoke provided with the means of the invention.

As may be seen in FIG. 1, the lines of force By, which are vertical to simplify matters, are the main lies of force of the magnetic field produced in the horizontal plane gap of the inductor (not shown in the figure). They therefore represent a magnetic force field which is uniform and well controlled, both in terms of intensity and spatial topology, since it is controlled by the inductor itself.

The yoke 1, formed by a stack of magnetic steel laminations 3, is laminated in the direction of propagation of this field Bv. This arrangement, intended to create metal discontinuities, prevents the formation of eddy currents within the yoke in the plane of the gap, which is therefore the plane perpendicular to By. Thanks to this arrangement, only edge loops are allowed to form therein, i.e. induced current circulation loops 5 along the thickness direction of the laminations, and therefore small low-energy loops.

However, other, parasitic current circulation loops 6 may be generated in the very plane of the laminations. These loops are of much higher energy than the above loops and the resulting Joule effect on the overheating of the yoke is otherwise more substantial since it is then the entire surface of the laminations which acts as seat for establishing these parasitic electrical currents. This situation arises when the lines of force Bt of the incident magnetic field produced by the inductor are, entirely or at least with a major component, oriented in a direction perpendicular to By and therefore directed, as shown in the figure, perpendicular to the plane of the laminations. This may occur if the inductor is placed in the immediate vicinity (and therefore generally in the corners of the yoke) of an environment having magnetic properties exhibiting strong anisotropy, capable of “capturing” a fraction of the vertical field lines Bv and channelling them along a return circuit on the yoke, giving them a predominantly horizontal orientation Bt, and therefore perpendicular to the plane of the laminations 3.

This is the case when bulky metal infrastructures and/or superstructures are required, if only for supporting one or more large powerful inductors and for keeping them in a stable position, precisely like the inductors of plane structure generating a travelling magnetic field that are intended for rapidly heating metal strip running rapidly for example through a continuous steel strip annealing furnace.

As shown in FIG. 2, to alleviate the troublesome thermal consequences of such a situation on the inductor, the invention simply consists in providing edge notches 7 in the yoke laminations (said laminations being denoted here by the reference 4 in order to differentiate them from the conventional unnotched laminations 3 of FIG. 1). Therefore, complementary metallic discontinuities are produced that allow the induced currents the possibility of forming and spreading only in the confined spaces available between the notches. For example, if the notches are separated from one another by a distance equal or close to the thickness of the laminations 3 (i.e. about 1 to 4 mm), the full-face parasitic current loops 8 that could develop will be of the same type and therefore as low in energy as the edge loops 5, thereby resulting in a substantial lowering in inductor overheating. Experience shows that a significant result on the thermal behaviour of the inductor could be obtained with inter-notch spacings that may range up to 5 cm, even if the best results are achieved with distances of 1 cm, and less, of course.

The notches start at the lamination edges and extend, preferably along straight lines, towards the interior over a distance, ranging from a few cm to a few dm, that depends on the environment of the inductor.

They are produced by removing material, by simply cutting using for example a circular saw, so that each notch has non-touching lips (“open” lips), and preferably with no mutual, even discrete, contact, so as to prevent offering bridges for the circulation of eddy currents thereat.

1. Heating inductor yoke of plane general structure for generating a travelling magnetic field, said yoke being formed from a stack (2) of magnetic laminations (4), characterized in that said laminations (4) making up the magnetic yoke (1) have mutually parallel edge notches (7) with open lips, these being located at least in the corners of the inductor.

2. Yoke according to claim 1, characterized in that said notches (7) are preferably spaced apart by a few mm and more, without exceeding 5 cm.

3. Yoke according to claim 1 or 2, characterized in that said notches (7) start at the lamination edges.

4. Yoke according to claim 1, characterized in that said notches (7) are produced by removing material so that each notch has open lips.
